(19) United States
(12) Patent Application Publication
(10) Pub. No.: US 2025/0282154 A1
(43) Pub. Date: Sep. 11, 2025

(54) METHOD AND APPARATUS FOR PRINT DRYING OPTIMIZATION AND HYBRID DRYING

(71) Applicant: Electronics for Imaging, Inc., Londonderry, NH (US)

(72) Inventor: Manuel Escudero Verchili, Castellon de la Plana (ES)

(21) Appl. No.: 19/070,842

(22) Filed: Mar. 5, 2025

(30) Foreign Application Priority Data
Mar. 7, 2024 (ES) P202430166

(51) Int. Cl. B41J 11/00; B41M 7/00

(52) U.S. Cl. CPC B41J 11/00212; B41J 11/00214; B41J 11/00216; B41M 7/0081; B41M 7/009

(57) ABSTRACT

A method is provided for optimizing print drying in which the printer analyzes an image to be printed. A source of energy used to cure/dry ink/primer each time the image is ready to be printed is determined, and a best orientation of the image is selected to optimize energy consumption and energy applied to the substrate. In an alternative method a drying profile corresponding to application of ink to the substrate is mapped to the image and, based on the mapping, power applied by an emitting radiation system to said substrate is adjusted. A further embodiment comprises a hybrid drying system that uses in combination an IR/NIR lamp and diodes or other sources of power that are rapidly modulated and have quick response times while exhibiting low thermal inertia.

### CROSS-REFERENCE TO RELATED APPLICATIONS

This application claims the benefit of Spanish Application No. 202430166 filed Mar. 7, 2024, the content of which is incorporated in its entirety.

### TECHNICAL FIELD

Various of the disclosed embodiments concern print drying optimization and, in particular, the order and orientation of print jobs. Further, various of the disclosed embodiments concern hybrid drying and, in particular, using a combination of infrared lamps/arc lamp technology and LED/laser technology for curing or drying the ink in a sheet-to-sheet industrial single pass printing machine.

### BACKGROUND

### Print Drying Optimization

Inkjet technology is improving every year and appearing in new areas of application. There are many types of inks, but water-based inks are becoming one of the most interesting types of inks for digital printing due to the advantages that they offer, which include such factors environmental friendliness, health, and safety as well as economics and profitability. And therefore, the market is moving to this kind of ink.

One of the biggest challenges in high-speed inkjet printers is how to dry the ink. Many manufacturers are trying to find the best way to dry ink and there are different kinds of technologies. The main methods that are currently used to dry ink include absorption drying, evaporation drying, oxidation and polymerization drying, and finally, radiation drying.

In cases where chemical and physical drying are not enough, radiation drying may be the best way to dry ink. There are different kinds of radiation drying depending on the wavelength of radiation which is used. These include ultraviolet radiation, infra-red radiation, microwave radiation, and radio frequency radiation. Each method is determined by the ink chemistry and the nature of the ink used.

Infra-red (IR) drying methods are among the most used due to the high speed of printing required by digital printing. In infra-red drying, there are no mechanical effects such as jetted hot air or a heating belt which heats a substrate by conduction. IR radiation provides large amounts of energy in a short period of time. When the ink absorbs the energy it starts to heat up and, when it reaches a sufficiently high temperature, the water in the ink begins to evaporate, thus allowing to the system to dry the ink in a short period of time.

For IR drying there are different types of technologies, depending on the wavelength of the IR. Thus, there are near-infra red lamps, medium infra-red lamps, and long infra-red lamps. Depending on the substrate and coating, one or other could be the most useful. Moreover, there are suppliers that combine IR technology with a jet of hot air to improve the evaporation of the ink and to improve the performance of the system.

Each customer orientates a print job and in case of a stack of multiple jobs order the print job without considering the energy performance and cost saving. However, printing at high speeds requires an increase in the energy dose for IR drying. This requires a lot of energy, which means increased power consumption.

Moreover, applying such high energy also affects the substrate which, in inkjet industry, produces problems such as warping of the substrate. Because it is necessary to apply high energy to evaporate water from the ink, the same energy is also applied to the substrate, also removing water therefrom. Therefore, dryers normally have a long second stage of cooling to reduce warping and reduce possible problems in future stages of the printer such as, for example, the application of an over varnish or to cut the substrate without warping problems.

Currently, print jobs are not analyzed before printing and significant amounts of energy are lost because the printer is not working under optimum conditions, thus increasing all of the foregoing problems.

### Hybrid Drying

Nowadays, manufacturers of industrial printers use such methods to cure and dry as, for example, mercury lamps or LED lamps. For drying there are a wide range of types of methods in the market, but the most used in digital printing is IR technology.

Ultraviolet curing (commonly known as UV curing) is a photochemical process in which high-intensity ultraviolet light is used to instantly cure or dry inks, coatings, or adhesives. UV formulations are liquid monomers and oligomers mixed with a small percent of photo initiators, and then exposed to UV energy. In a few seconds, the formulation-inks, coatings, or adhesives-instantly harden or cure, and are then ready for the next processing step.

Printing at high speeds requires an increase in the energy dose of the drying/curing system, resulting in significant power consumption. Moreover, applying such high energy also affects the substrate which, in inkjet printing, produces problems such as warping of the substrate. Because it is necessary to apply high energy to evaporate the ink and the same energy is also applied to the substrate, an excessive amount of water is removed from the substrate. Therefore, dryers normally have a long second stage of cooling to reduce warping and also reduce possible problems in future stages of the printer, which stages could include for example the application of an over varnish or cutting of the substrate.

Further, due to limitations of IR technology, techniques that are used to modulate the light to apply energy only where it is needed are very expensive and, in terms of energy consumption, there are not very efficient.

### SUMMARY

An embodiment of the invention provides a method for optimizing print drying. In this embodiment the printer analyzes an image to be printed. A discretization of a source of energy that is used to cure/dry ink/primer each time the image is ready to be printed on a substrate is determined, and a best orientation of the image is selected to optimize energy consumption and energy applied to the substrate to reduce energy consumption, warping, and to optimize printer performance.

Moreover, in case of multiple images printed sequentially, this invention also provides the best order for printing the images taking into account thermal inertia of the curing/drying system and the energy required to dry/cure the printed images.

A further embodiment of the invention provides a hybrid drying system. Embodiments use an infrared/near infrared (IR/NIR) lamp system (or arc lamps in case of UV ink) combined with the use of diodes or other sources of power that are rapidly modulated and that have quick response times while exhibiting low thermal inertia.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an image to be printed;

FIG. 2 is a color bar showing different energies, e.g. from 0%-100%, that may be used to dry each section of an image in an optimal way;

FIGS. 3 and 4 show an image in which the color bar of FIG. 2 is used as a reference for power applied by an emitting radiation system, e.g. UV curing, drying, in this case with a power discretization of 48 sections, where the substrate in FIG. 3 has a first orientation relative to the printer transport and emitters and where the substrate in FIG. 4 has a second orientation relative to the printer transport and emitters that is perpendicular thereto;

FIG. 5 is flow diagram showing a method for adjusting the orientation of a substrate to improve the energy efficiency of a printer according to the invention;

FIGS. 6-11 show multiple images on a substrate where there is a distance between each of the images;

FIG. 12 is a graph that shows the % of optimization of energy, considering a speed of 100 meters per minute, a thermal inertia of 1 second, and a gap of 200 mm between pieces, where each piece has dimensions of 1400×1100 mm;

FIG. 13 is flow diagram showing a method for adjusting power applied by an emitting radiation system for ink drying to improve energy efficiency of a printer according to the invention;

FIG. 14 is a block diagram showing a hybrid drying system according the to the invention;

FIG. 15 is a flow diagram showing a method for effecting hybrid print drying according to the invention;

FIG. 16 shows the amount of colors dried vs. the NIR power required to dry various colors that are used in printing;

FIG. 17 is an accumulative graph that shows how power required to dry the various colors varies;

FIG. 18 shows a comparison on how effective laser technology is in a spectral working window compared against other technologies; and

FIG. 19 is a block diagram of a computer system as may be used to implement certain features of some of the embodiments.

### DETAILED DESCRIPTION

### Print Drying Optimization

A first embodiment of the invention provides a method that analyzes an image and takes into account the discretization of the source of energy that is used to cure/dry the ink/primer each time that an image is ready to be printed. This embodiment of the invention calculates the best orientation of the image to optimize the energy consumption and energy applied to the substrate to reduce energy consumption, warping, and to optimize performance of the process. This could be done automatically from the user interface. In case reorientation of the substrate itself is required, instead of merely reorienting the image on the substrate, e.g. where a new orientation of the image may not fit on the original orientation of the substrate on the printer, a signal to turn the substrate, manually or automatically, is provided if the feeder system allows such reorientation of the substrate.

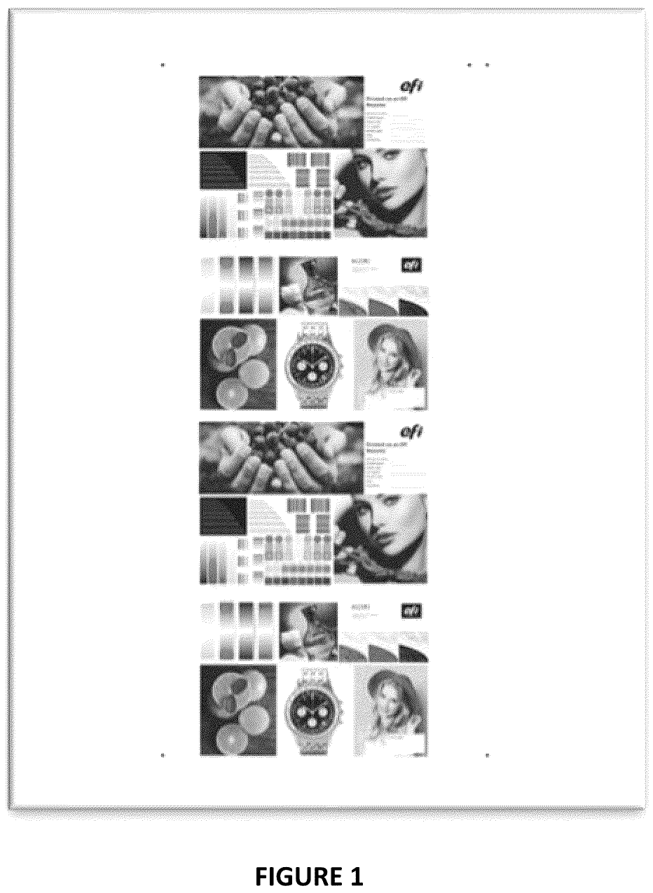

For example, given the image of FIG. 1, there are different possible energy savings depending on how the image is aligned in the printer. The drying lamp (emitter) area of the printer in this example is divided in 48 sections. See, for example, FIGS. 3A/3B in U.S. Ser. No. 18/184,589, filed Mar. 15, 2023, which application is incorporated herein in its entirety by this reference thereto, which figures show an image of an avocado that is discretized with twelve drying lamps and, depending on the response time of the light source, allows discretization with more or less applied energy. Those skilled in the art will appreciate that the are many different emitter arrangements that may be used in connection with the invention herein disclosed.

Further, the purposes of the discussion herein the terms “light sources,” “lamps,” and “emitters” are used interchangeably.

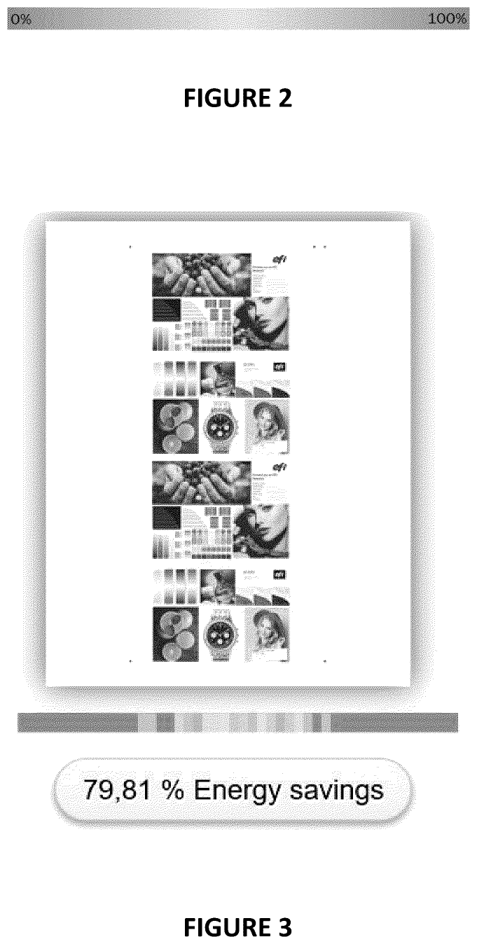

Each of the lamps could be set at different energies, e.g. from 0%-100%, as shown for example by the color bar in FIG. 2, to dry each section of the image in an optimal way. Drying/curing lamps are adjusted automatically depending on the image to dry/cure. All of this is processed automatically by software (see, for example, commonly assigned U.S. patent application Ser. No. 18/184,589, filed Mar. 15, 2023, which application is incorporated herein in its entirety by this reference thereto). Thus, areas that have received more ink, i.e. those areas that are wetter, receive more drying radiation and those areas that have received less or no ink, i.e. those areas that area drier, receive less or no radiation.

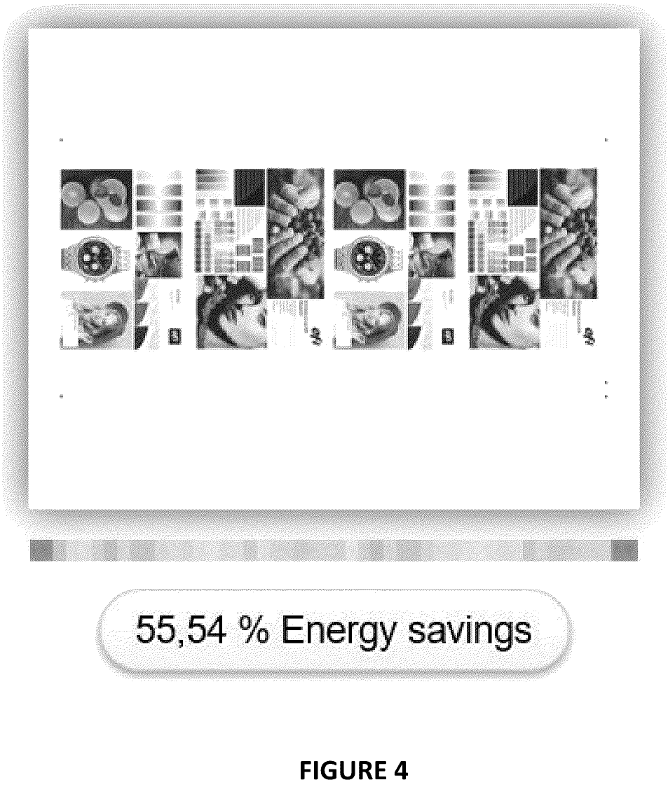

FIGS. 3 and 4 show an image in which the color bar of FIG. 2 is used as a reference for power applied by an emitting radiation system, e.g. UV curing, drying, where the substrate image in FIG. 3 has a first orientation relative to the printer transport and where the substrate in FIG. 4 has a second orientation relative to the printer transport that is perpendicular thereto. By adjusting the power applied to the emitters in accordance with this embodiment of the invention the amount of energy applied to the image of FIG. 3 results in a 78.91% power savings and the amount of energy applied to the image of FIG. 4 results in a 55.54% power savings. As such, embodiments of the invention reduce energy requirements and thus significantly reduce greenhouse gases.

In the example of FIG. 4 energy savings are less when the substrate is aligned in the same direction as that of the lamps, i.e. perpendicular to the belt direction. Moreover, it is important to take into account the time that the lamps are enabled because when the substrate is moved in that direction the exposure emitter time is shorter. The improvement is around 73% less energy used if the substrate is aligned in the process direction, i.e. left image, long side in the belt direction movement. Depending on the image it could be better to use one or the other orientation. The amount of improvement is determined by taking into account the time that the emitter is enabled or not enabled. In case of FIG. 3, the time that the emitter is enabled is shorter because the time that the substrate is in the process direction is shorter. The energy saving calculations from both orientations as shown, for example in FIG. 3 (79.81%) and FIG. 4 (55.54%), are compared resulting in a 73% energy saving between orientations. These calculations were obtained by taking into account the energy emitted for each emitter with the optimized algorithm and comparing the savings if the emitters are operated at 100%. The printer can determine the most efficient substrate orientation in advance by analyzing the image.

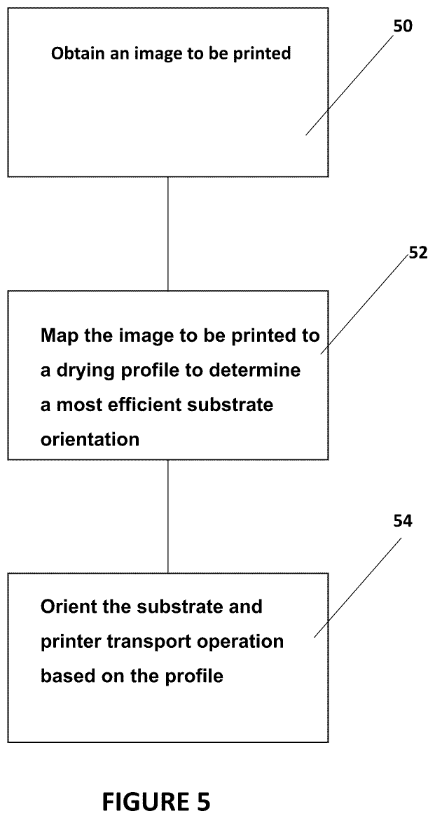

FIG. 5 is flow diagram showing a method for adjusting the orientation of a substrate to improve energy efficiency of a printer according to the invention. In accordance with this embodiment of the invention, an image is obtained by the printer 50. In embodiments of the invention the image is raster image processed to get information regarding the amount of ink that is to be jetted by the printheads and determine the equivalent drying power required. Thus, the image is processed 52 to characterize the distribution and features of ink that the printer is to apply across the surface of a substrate in each of two substrate orientations, i.e. aligned in the process direction and aligned perpendicular to the process direction. For purposes of the discussion herein, features of the ink include any of the density of the ink, color, substrate absorbance, etc. In this way, a drying profile is mapped to the image that corresponds with the orientation of the substrate. The profile establishes a series of control signals that operate the printer transport and substrate feed mechanism 54 to orient the substrate for greatest energy efficiency.

In other embodiments the image may be processed in this way before being provided to the printer.

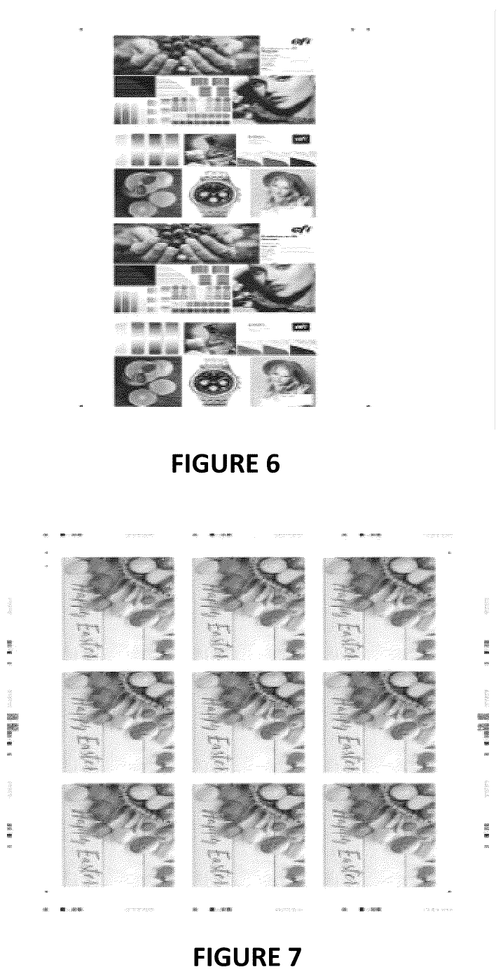

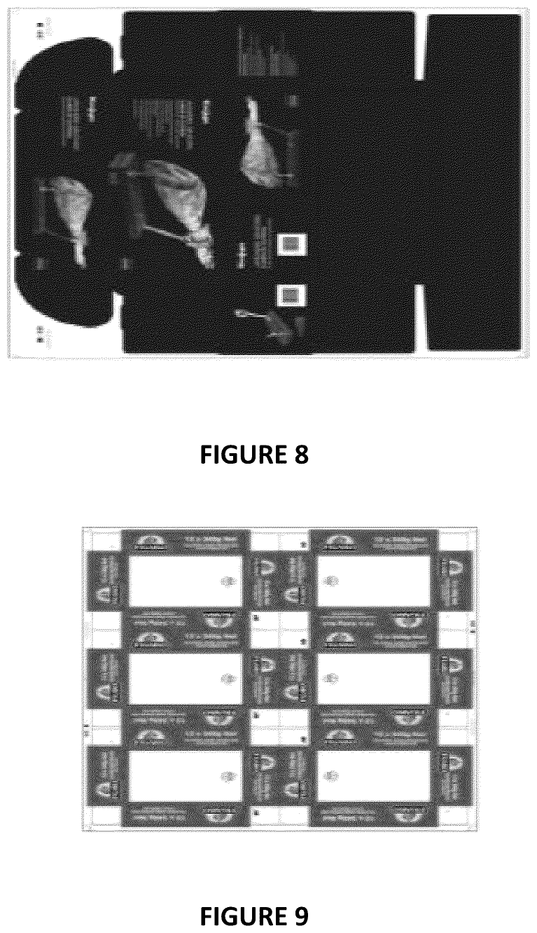

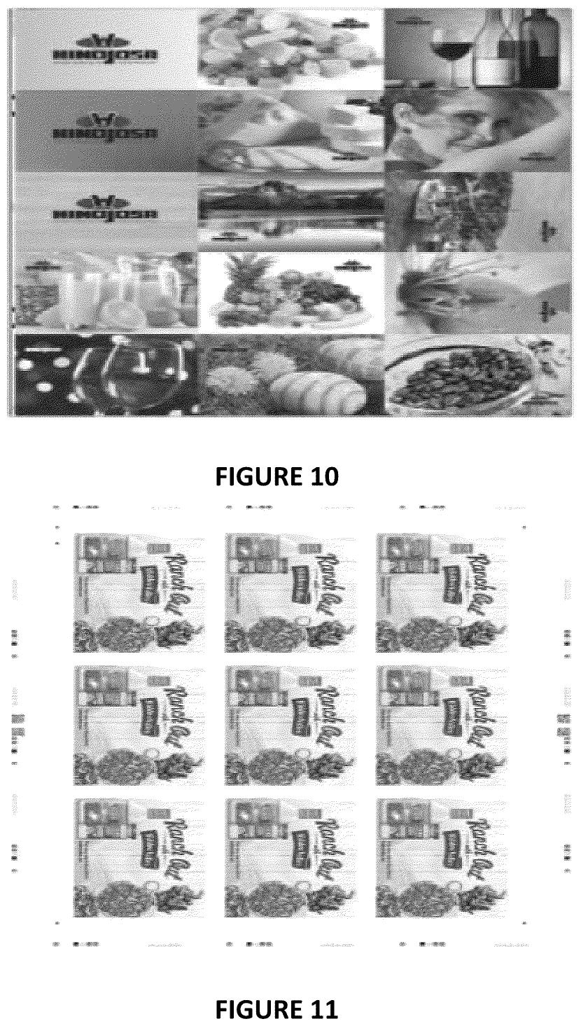

In other embodiments of the invention another optimization can be applied in the case that a print job has multiple images. This is the case that some images are printed sequentially in the same job. For example in the images shown in FIGS. 6-11—which are example images with different combinations of colors that explain the herein disclosed invention and the opportunities that it provides—there is some distance between images and lamps used for curing/drying system exhibit thermal inertia. Therefore, it is necessary to take this thermal inertia into account such that the lamps are prepared at a desired set point when the image arrives. In embodiments of the invention thermal inertia is taken into account to change the power automatically by calculating all the possible combinations of the images and the energy that is used in all such combinations and then evaluating and proposing the best combination of the images.

This embodiment of the invention analyzes all different combinations of emitter operation and finds the best combination to ensure that the minimum amount of energy is used and that all performance parameters, e.g. warping, drying, curing, etc., are optimized.

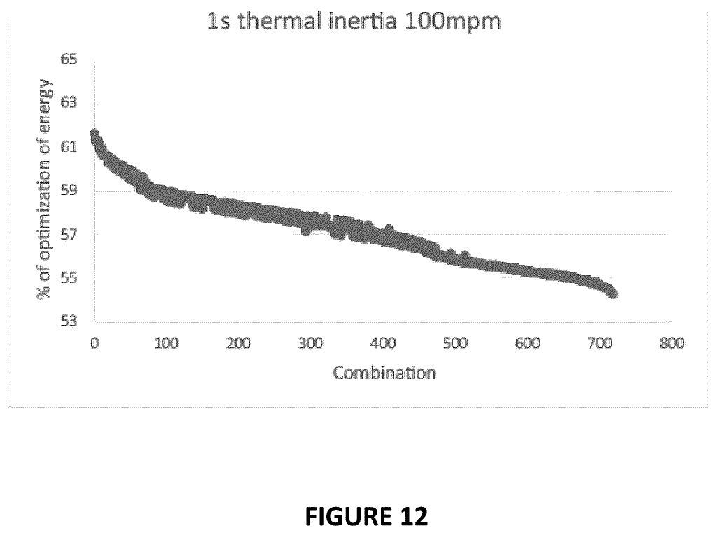

FIG. 12 is a graph that shows the % of optimization of energy, considering a speed of 100 meters per minute, a thermal inertia of 1 second, and a gap of 200 mm between images, where the dimensions of each image are 1400×1100 mm. Depending on the combination, % of energy optimized varies around 8-10%. This method preprocesses emitter operation and gives the user the best combination to have the maximum optimization available. At the same time such energy optimization has the environmental impact of reducing greenhouse gases that would have otherwise been created to generate the additional energy required by conventional printers that do not practice the herein disclosed invention.

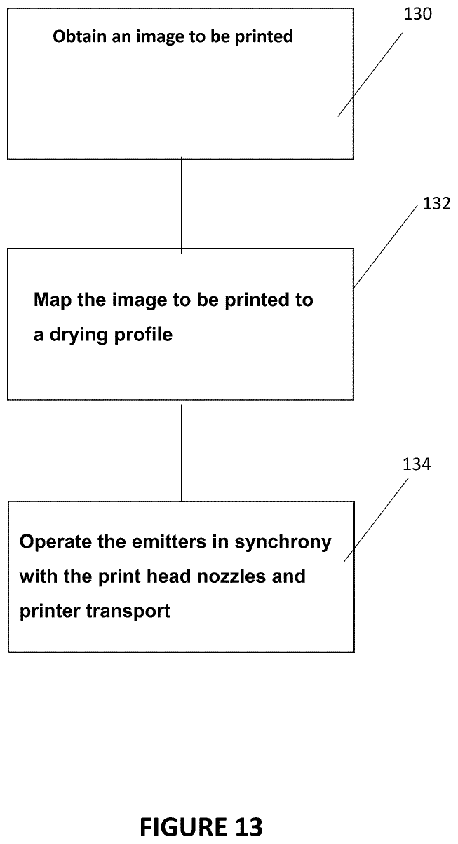

FIG. 13 is flow diagram showing a method for adjusting power applied by an emitting radiation system to improve energy efficiency of a printer according to the invention. In accordance with this embodiment of the invention an image is obtained by the printer 130. The image is processed 132 to characterize the distribution and features of ink that the printer is to apply across the surface of a substrate. In this way, a drying profile is mapped to the image that corresponds with the application of ink to the substrate. The profile establishes a series of control signals that operate the emitters 134 in a substantially synchronous fashion with the nozzles of the print heads and the transport mechanism of the printer such that after the substrate is advanced past the print head nozzles the emitters are operated to dry those portions of the substrate to which ink has been applied, taking into account as appropriate thermal inertia of the emitters and coincidence of the substrate with the emitters. In embodiments of the invention each emitter is controlled individually. This not only applies to multiple images but the emitters can also be adjusted across a single image as in FIGS. 3 and 4.

In other embodiments the image may be processed in this way before being provided to the printer.

As the printer operates the print heads to apply ink to the substrate, control signals are sent to the emitters to turn the emitters on and off and to set the emitter intensity in a specified manner such that selected intervals and levels of drying are applied to the substrate for each of the emitters.

When analyzing the image to determine optimum image orientation the printer, in addition to selecting optimum image orientation, embodiments of the invention can also consider the specific inks that are to be applied to the substrate (see, for example, commonly assigned U.S. patent application Ser. No. 18/184,589, supra). This avoids image quality problems related to application of extra energy to some ink formulations that do not require such heat where increasing the temperature can cause the appearance of burn marks, e.g. in black areas or with very dark colors having a high heat absorptance rate.

When analyzing the image to determine optimum image orientation the printer, in addition to selecting optimum image orientation, embodiments of the invention can also consider parameters of the substrate in the profile used to determine substrate orientation and emitter operation (see, for example, commonly assigned U.S. patent application Ser. No. 18/184,589, supra). For example, some substrates are more absorbent and may require more drying energy, while other substrate are sensitive to heat and may require more drying time. This embodiment of the invention can include a substrate type parameter when determining printer operation to dry ink that was applied to a substrate.

Embodiments of the invention find application in industrial inkjet printers, among others. The herein disclosed technique is applied to curing and drying systems for all types of inks, e.g. UV based, water based, hybrid, to analyze print jobs and optimize the way that they are processed to provide the best performing conditions.

Further, both embodiments of the invention may implemented at the same time where a determination is made regarding both substrate orientation relative to the emitters and operation of the emitters themselves, including thermal inertia. In some embodiments of the invention a default substrate orientation is preferred where it is not necessary to rotate the image to obtain optimal print drying efficiency. For example, in some cases a particular substrate orientation may produce greater energy savings in addition to any energy saving that may be provided by selective operation of the emitters, while in other cases selective operation of the emitters alone provide the greatest energy savings without regard to substrate orientation. Embodiments of the invention can process the image to determine the best substrate orientation and emitter operation sequence prior to actual application of ink to the substrate.

Applying the technique herein disclosed to analyze a print job and propose the best ink drying solution provides at least the following benefits:
There is an energy savings of about 10%. Considering that conventional ink drying techniques require substantial amounts of energy, substantial cost savings are realized when taking in account the amount of energy saved.
Printers that include this technology are more environmentally friendly because the use of energy is optimized, thus significantly reducing greenhouse gas production.
The use of the energy is optimized and the application of an extra dose of energy is avoided where it is not needed by organizing the orientation and order of jobs for energy efficiency.
Due to the reduction of warping, embodiments of the invention allow reduction of the length of the printer because a long cooling station is not needed, i.e. the printer generates less heat.
Image quality problems related to application of extra energy are avoided with ink formulations that do not require as much heat, where increasing the temperature of these inks in some cases would otherwise result in the appearance of burn marks, e.g. in black areas or with very dark colors having a high heat absorptance rate.

### Hybrid Drying

Embodiments of the invention provide a hybrid drying system that uses an IR/NIR (infrared/near infrared) lamp system (or arc or UV lamps in case of UV ink) combined with the use of diodes, lasers, or other sources of power which are modulated faster with quick response times and low thermal inertias when compared with infrared lamps. The difference in modulation time is dependent on the type of technology. For example, an LED can be turned on and off in milliseconds, while IR lamps have a response time of around one second. Accordingly embodiments of the invention concern different modulations of light, where one technology is faster than other.

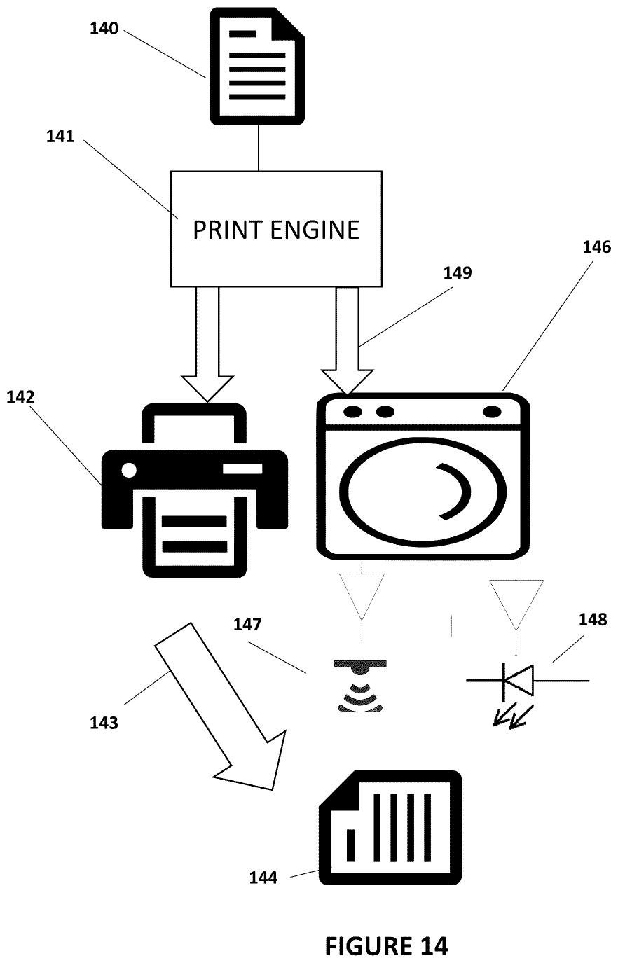

FIG. 14 is a block diagram showing a hybrid drying system according the to the invention. In FIG. 14, a substrate 144 is presented to a printer 142 for printing along a print path 143. After printing, the substrate is presented to a dryer 146 which, in embodiments of the invention comprises first drying stage 147 comprising standard modulation drying technology, such as an IR/NIR lamps system, and a second drying stage 148 comprising a quick modulation drying technology such as a diode system. When modulating the various drying sources the system optimizes the energy used depending on energy requirements of each image. Other embodiments of the invention can be implemented to use quick modulation at a first stage and then, use slow modulation system at a second stage.

In embodiments of the invention, the printer transport can also controlled to affect the speed at which the substrate is advanced past the lamps/LEDs.

In embodiments of the invention the dryer can be part of the printer or it can be a separate device. Further, in embodiments of the invention a cooling step can be included in the drying system as part of the process.

Modulation of light depends on the response time of the light sources. Having quick response times allows more discretization of the energy applied. For example, with a printed sample that takes one second to pass through drying system, low speed modulation technology can not address different energy powers along the image because such light technology does not allow doing so and it is therefore necessary to apply the maximum energy required along the image. On the other hand, if a fast modulation source is used it is possible to adjust the light quickly and discretize the energy along the image to optimize the energy applied. Embodiments of the invention use both technologies at same time. Because quick modulation sources are more expensive it is advantageous to apply one part of the energy with a low-speed modulation source and another part with a quick speed modulation source, resulting in an optimized system without significantly increasing the cost of the system.

In embodiments of the invention, an image 140 is processed by a print engine 141. In embodiments of the invention the print engine considers the complete gamut of colors to be printed and evaluates how much power is required to dry each color, taking into account the spectrums of absorbance. Accordingly, the image is analyzed to map the various colors and locations of the colors on the image to a drying modulation scheme that modulates either or both sets of the dryer lamps and diodes in coordination with the locations of various colors on a printed image. Accordingly, various locations on the printed substrate are subjected to more or less drying energy from either or both sources as is necessary to effect drying while using a minimal amount of energy. The map thus determined is provided as a signal 149 to the dryer to modulate either or both sets of the dryer lamps and diodes in coordination as appropriate.

Those skilled in the art will appreciate that the print engine may be part of the printer itself, it may be a stand-alone hardware facility, or it may be implemented in software as a local or remote app or tool.

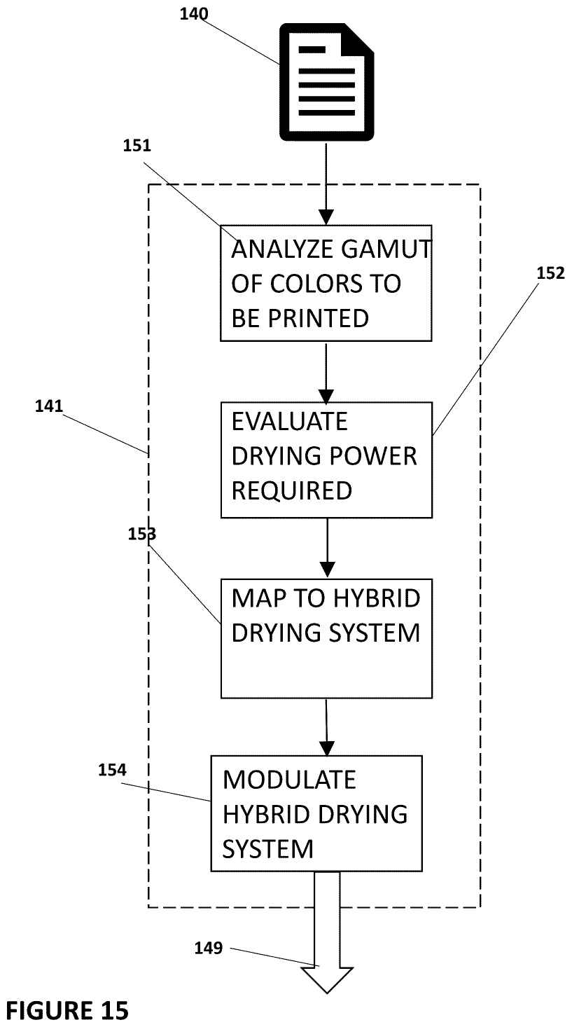

FIG. 15 is a flow diagram showing a method for effecting hybrid print drying according to the invention. In FIG. 15, the image 140 is processed by the print engine 141. The print engine analyzes the gamut of colors to be printed for the image 151 and evaluates the drying power required to effect drying 152 that both provides the most efficient use of energy and that dries the printed substrate to avoid such flaws as warping, etc. The print engine maps the image to the hybrid drying system 153 and a signal is generated based on the mapping 154 that is routed 149 to the dryer to modulate either or both sets of the dryer lamps and diodes in coordination as appropriate.

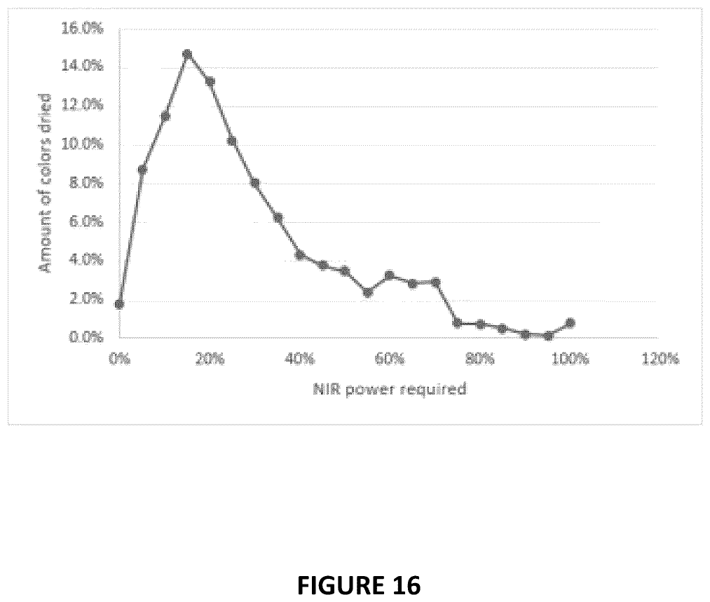

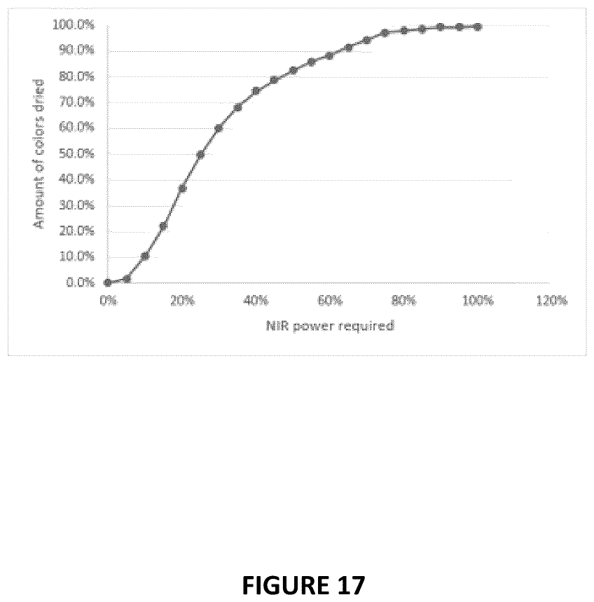

FIG. 16 shows the amount of colors dried vs. the NIR power required to dry various colors that are used in printing. FIG. 17 is an accumulative graph that shows how power required to dry the various colors varies. As can be seen in FIGS. 16 and 17, 100% of power is required to dry a worst case color while it is possible to dry more than a 70% of the colors using only around 30% of the total power, i.e. with a 30% of the NIR power it is possible to dry around the 70% of possible combinations of ink that could be printed.

Taking this into account, embodiments of the invention provide, for example, 50% of the whole power using infrared lamps or a source of power which does not need have a quick response to modulation, and moreover it is a cheaper technology. The other 50% of energy source comprises an array of diodes/lasers or similar technology which allows quick modulation of light. Embodiments of the invention combine both kinds of technology to dry ink jetted onto an image dependent on the image to provide the most efficient drying combination by selectively modulating the two different sources of light.

As part of the mapping process discussed above, in additional embodiments of the invention the print engine may also resort to one or more look-up tables (LUTs) that include lamps and diode energy/modulation values for each color that is identified in an image to be printed. The LUT values are then used to modulate the lamps/diodes to optimize the drying of ink applied to the substrate while reducing energy consumption, thus reducing the generation of greenhouse gases.

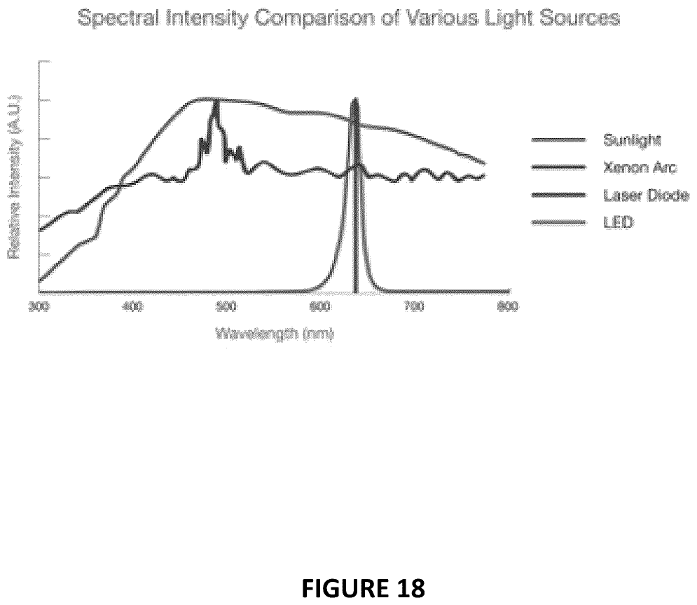

In embodiments of the invention the laser/diodes emit light in different spectrum ranges depending on the application required. In case of UV ink, the laser/diodes emit light in a range from 300-400 nm to optimize the light emitted to the desired broadband spectrum of absorptance of the photo initiators in the ink formulation and thus cause the ink to be cured. In the case of an ink drying application, the laser/diodes emit light around 950 nm in the NIR range to optimize the drying capabilities and avoid wasting energy when dehydrating the printed substrate. See FIG. 18, which shows a comparison on how effective laser technology is in a spectral working window compared against other technologies. FIG. 18 shows the spectral emission of each kind of source, comparing how LED and laser technologies could be efficient because only the wavelength that is needed to be used for drying is applied where, for example, other technologies such as xenon arc emit other wavelengths that negatively affect the printed substrate, for example by warping the substrate or generating other negative impacts.

Unlike the state of the art which applies the same energy to the whole image to dry/cure due to the limitations in modulation times of the conventional drying/curing technologies (e.g. arc lamps, infrared lamps . . . ), embodiments of the invention allow the energy applied for drying the ink to be modulated where it is needed. This approach avoids applying energy to areas of the printed substrate where it is not needed, for example where ink has not be applied to the substrate. This approach optimizes the use of energy to reduce waste energy close to zero without the need of make a huge investment. Significantly, the reduction in energy use reduces greenhouse gas emissions by reducing the demand for generated energy to operate the printer and dry printed substrates. This optimized use of the energy also avoids problems of warping the substrate due to a dehydration, for example when excessive energy is applied to the substrate.

Embodiments of the invention find use, for example in industrial sheet-to-sheet inkjet single pass printers and other printers. Embodiments of the invention apply to curing and drying systems, for all types of inks (UV based, water based, hybrid . . . ).

Some benefits provided by the invention include:
Energy saving because the herein disclosed inventive technology is more precise in applying an energy dose to dry printed substrates.
Cost saving, because the herein disclosed hybrid solution does not require an investment in a full diode/laser system to have full capability of modulation. Thus, the system only uses a percentage of the drying required power, depending on the color requirements of the inks to be dried.
The system reduces the generation of greenhouse gases because it optimizes the use of energy.
The system applies the desired wavelength to the type of ink to be dried and thus avoids working in spectrums that are not efficient in the drying/curing process.
The system modulates the energy at the dose required instantaneously due to the kind of technology and low thermal inertia that it has, for example using diode or laser technology, which is a quick modulation technology.
Due to the reduction of warping, the system allows reduction in the length of the printer because a long cooling station is not needed.
The system avoids image quality problems related to application of extra energy to some mixings of inks that do not require high energy levels to dry where increases in temperature in some cases appear as burning marks, mostly in black areas or very dark colors with a high absorptance rate.
The system allows higher power densities than used in other technologies, for example in case of using laser technology, there are lasers available that reach 100 w/cm² and in case of IR or UV lamps values are around 20 w/cm². This enables shorter drying/curing times, thus improving the quality of the printing and while avoiding dehydrating the sheets and not generating related problems.
The combination of both kinds of technologies reduces the need for a large investment in a full quick modulation system, while providing the same benefits due to the color power requirement distribution.
Using 50% of each technology, the worst case would be an image which would need 80% of power in one place while no power would be needed elsewhere where there is no ink. For example, the herein disclosed hybrid technology would only overheat the non-ink side only at 30%, where quick modulation technology is the 50%. In case of black colors, which only need around 40% of power to dry and in case of apply high power doses the output temperature of the ink is very high, which generates problems of application an over varnish. In case of no using hybrid technology or technologies that do not allow a quick modulation of light, for ink combinations that require low power to dry (for example black) it would be necessary to apply also the required energy to dry the worst case because it not has the capability to adjust quickly. This means that the printed substrate is overheated in some parts of the image generating a bad impact in the output of the system, such as warping, burning, etc.

### Computer Implementation

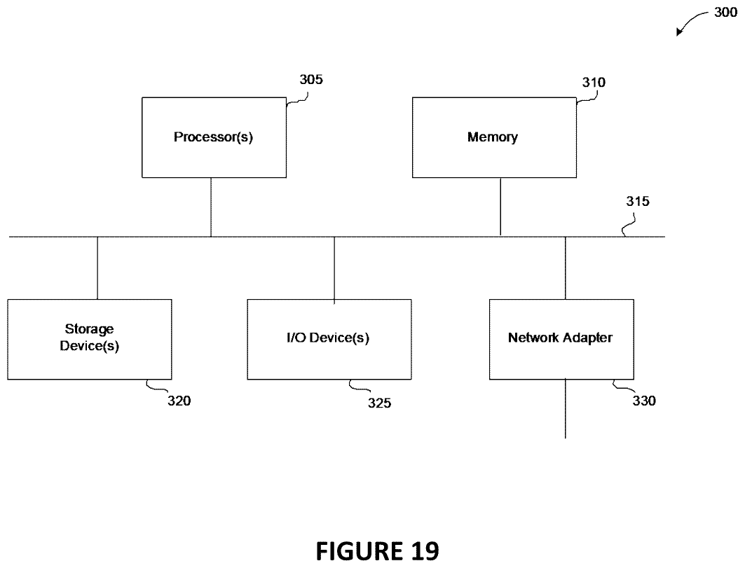

FIG. 19 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 300 may include one or more central processing units (“processors”) 305, memory 310, input/output devices 325, e.g. keyboard and pointing devices, touch devices, display devices, storage devices 320, e.g. disk drives, and network adapters 330, e.g. network interfaces, that are connected to an interconnect 315. The interconnect 315 is illustrated as an abstraction that represents any one or more separate physical buses, point to point connections, or both connected by appropriate bridges, adapters, or controllers. The interconnect 315, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called Firewire.

The memory 310 and storage devices 320 are computer-readable storage media that may store instructions that implement at least portions of the various embodiments. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 310 can be implemented as software and/or firmware to program the processor 305 to carry out actions described above. In some embodiments, such software or firmware may be initially provided to the processing system 300 by downloading it from a remote system through the computing system 300, e.g. via network adapter 330.

The various embodiments introduced herein can be implemented by, for example, programmable circuitry, e.g. one or more microprocessors, programmed with software and/or firmware, or entirely in special purpose hardwired (non-programmable) circuitry, or in a combination of such forms. Special-purpose hardwired circuitry may be in the form of, for example, one or more ASICs, PLDs, FPGAs, etc.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

I/We claim:

1. A method for optimizing print drying, comprising:
analyzing an image;
determining discretization of a source of energy that is used to cure/dry ink/primer an image each time the image is ready to be printed on a substrate; and
calculating a best orientation of the image to optimize energy consumption and energy applied to the substrate to reduce energy consumption, warping, and to optimize printer performance.

2. The method of claim 1, further comprising:
establishing a first orientation relative to a printer transport;
establishing a second orientation relative to the printer transport that is substantially perpendicular thereto; and
based on said analyzing adjusting power applied to said emitters to reduce energy requirements and significantly reduce greenhouse gases.

3. The method of claim 2, further comprising:
said analyzing taking into account a time that said emitters are enabled in said first orientation and in said second orientation and selecting an orientation for a process direction in which emitter exposure time is shorter.

4. The method of claim 3, further comprising:
said analyzing calculating energy used in said first orientation and in said second orientation to determine power and time required to cure/dry ink/primer said image in each orientation; and
selecting a most energy efficient orientation for said image during printing.

5. A method for improving energy efficiency of a printer, comprising:
providing an image to said printer;
mapping said image to generate a profile that characterizes a distribution and features of ink that the printer is to apply across a surface of a substrate in each of two substrate orientations;
wherein in a first substrate orientation the substrate is aligned in a process direction and wherein in a second substrate orientation the substrate is aligned substantially perpendicular to the process direction;
based on said profile adjusting the orientation of the substrate to operate the printer transport to orient the substrate for greatest energy efficiency and reduction of greenhouse gases.

6. The method of claim 5, further comprising:
providing a source of energy comprising a plurality of emitters; and
individually setting each of said emitters at selected radiation energies from 0%-100 to dry each section of the image in an optimal way.

7. The method of claim 6, further comprising:
said profile taking into account a time that said emitters are enabled in said first orientation and in said second orientation and selecting an orientation for a process direction in which energy is less.

8. The method of claim 5, further comprising:
providing a print job that has multiple images in which some images are printed sequentially in a same job;
wherein there is a distance between images;
wherein emitters used for curing/drying exhibit thermal inertia;
said printer taking said thermal inertia into account to operate the emitters at a desired set point when the image arrives.

9. The method of claim 8, further comprising:
analyzing all different combinations of said multiple images; and
determining a best image order to ensure that the minimum amount of energy is used and that all performance parameters are optimized.

10. The method of claim 9, further comprising:
analyzing all different combinations of emitter operation for all combinations of said multiple images;
preprocessing emitter operation; and
determining a best combination of emitter operation and image order to ensure that the minimum amount of energy is used and that all performance parameters are optimized.

11. A method for improving energy efficiency of a printer, comprising:
providing an image to the printer;
processing the image to characterize distribution and features of ink that the printer is to apply across a surface of a substrate;
mapping a drying profile to the image that corresponds with application of ink to said substrate;
determining both substrate orientation relative to a plurality of emitters and operation of the emitters themselves to determine a best substrate orientation and emitter operation sequence prior to actual application of ink to the substrate; and
based on said determination orienting said substrate.

12. The method of claim 11, further comprising:
with said profile establishing a series of control signals that operate said plurality of emitters to dry ink in a substantially synchronous fashion with nozzles of print heads and a printer transport mechanism;
operating said emitters to dry those portions of the substrate to which ink has been applied after the substrate is advanced past the print head nozzles.

13. The method of claim 12, further comprising:
said operating of said emitters taking into account thermal inertia of the emitters and coincidence of the substrate with the emitters.

14. The method of claim 12, further comprising:
as the printer operates the print heads to apply ink to the substrate, sending control signals to the emitters to turn the emitters on and off and to set the emitter intensity in a specified manner, wherein selected intervals and levels of drying are applied to the substrate for each of the emitters.

15. The method of claim 11, further comprising:
said processing further identifying specific inks that are to be applied to the substrate to avoid image quality problems related to application of extra energy to said inks.

16. The method of claim 11, further comprising:
said processing including parameters of the substrate in the profile; and
said printer using profile including said parameters to determine substrate orientation and emitter operation.

17. The method of claim 16, wherein said profile provides more drying energy for substrates that require more drying energy and said profile provides less drying energy for that require more drying time.

18. A method for improving energy efficiency of a printer, comprising:
providing an image to the printer;
processing the image to characterize distribution and features of ink that the printer is to apply across a surface of a substrate;
mapping a drying profile to the image that corresponds with application of ink to said substrate;
determining both substrate orientation relative to a plurality of emitters and operation of the emitters themselves to determine a best substrate orientation and emitter operation sequence prior to actual application of ink to the substrate, wherein said plurality of emitters comprise two different sources of light; and
based on said determination orienting said substrate and selectively modulating said two different sources of light.

19. A method for print drying, comprising:
analyzing an image with a print engine by:
identifying a gamut of colors in said image that are to be printed on a substrate;
determining an amount of power required to dry each color in said gamut of colors, taking into account spectrums of absorbance; and
mapping said colors and locations of said colors on the image to a hybrid drying modulation system;
presenting the printed substrate to a dryer comprising:
a first drying stage comprising a first modulation drying technology; and
a second drying stage comprising a modulation second drying technology; and
modulating either or both of said first and said second drying stages based on said mapping of said colors and locations of said colors on said image;
wherein different colors and locations of said different colors on said image are subjected to more or less drying energy from either or both of said first and said second drying stages to effect drying of said image printed on said substrate with a minimal amount of energy.

20. The method of claim 19, wherein said first drying stage comprises an IR/NIR (infrared/near infrared) lamp system (or arc or UV lamps in case of UV ink); and
wherein said second drying stage comprises a diode, laser, or other sources of power which is modulated faster with quick response times and low thermal inertia when compared with said first drying stage.

21. The method of claim 19, further comprising:
when a quick response to modulation is not required providing a first percentage available power to said first drying stage.

22. The method of claim 19, further comprising:
when a quick response to modulation is required providing a second percentage available power to said second drying stage.

23. The method of claim 19, further comprising:
when a quick response to modulation is required providing a first percentage available power to said first drying stage.

24. The method of claim 19, further comprising:
when a quick response to modulation is not required providing a second percentage available power to said second drying stage.

25. The method of claim 19, said mapping further comprising:
accessing one or more look-up tables (LUTs) comprising modulation values for each color that is identified in an image to be printed.

26. The method of claim 23, further comprising:
based on said LUT values selectively modulating said first and second drying stages to optimize drying of ink applied to the substrate, reduce energy consumption, and reduce greenhouse gas generation.

27. The method of claim 19, further comprising:
said first and said second drying stages selectively emitting light in different spectrum ranges based on application requirements.

28. The method of claim 19, further comprising:
for UV ink that reacts from around 300-400 nm, said second drying stage selectively emitting light in a range from around 300-400 nm to optimize the light emitted to a desired broadband spectrum of absorptance of the photo initiators in an ink formulation and cure the ink.

29. The method of claim 19, further comprising:
said second drying stage selectively emitting light around 950 nm to optimize drying and avoid wasting energy.

30. The method of claim 19, wherein a reduction in energy use reduces greenhouse gas emissions by reducing demand for generated energy to dry printed substrates.

31. The method of claim 19, wherein a reduction in energy avoids applying excessive energy to the substrate to prevent any of warping, overheating, burning, or matting of the substrate.

32. The method of claim 19, further comprising:
applying a specified wavelength for a type of ink to be dried to avoid working in spectrums that are not efficient for drying/curing said type of ink.

33. The method of claim 19, wherein a reduction in energy reduces a need for a long cooling station and allows for a reduction in printer length.

34. The method of claim 19, further comprising:
applying higher power densities up to around 100 w/cm² for lasers and up to around 20 w/cm² for IR or UV lamps to provide shorter drying/curing times.

35. The method of claim 19, wherein said first drying stage comprises a standard modulation drying technology; and said second drying stage comprises a quick modulation drying technology.

36. The method of claim 19, wherein said second drying stage comprises a standard modulation drying technology; and said first drying stage comprises a quick modulation drying technology.
